(19) United States
(12) Patent Application Publication
(10) Pub. No.: US 2018/0246692 A1
(43) Pub. Date: Aug. 30, 2018

(54) Online Audio Delivery Detection in Audio/Video Streaming Services

(71) Applicant: International Business Machines Corporation, Armonk, NY (US)

(72) Inventors: Suresh N. Chari, Scarsdale, NY (US); Zhongshu Gu, Croton-on-Hudson, NY (US); Heqing Huang, Mahwah, NJ (US); Kapil K. Singh, Cary, NC (US)

(21) Appl. No.: 15/443,506

(22) Filed: Feb. 27, 2017

(51) Int. Cl. G06F 3/16; G06Q 30/02

(52) U.S. Cl. CPC G06F 3/165; G06Q 30/0241

(57) ABSTRACT

An approach is provided that receives audible signals from a microphone at a device. The approach compares the received audible signals to an expected audio signal, with the expected audio signal being a first segment playing at the device. A determination is made whether, based on the comparison, the first segment was played at an audible level at the device. If the first segment was audibly played, then the approach plays additional audible content (a second segment, etc.). On the other hand, if the first segment was inaudible, then the approach inhibits further playing of audible content, such as the second segment.

### BACKGROUND OF THE INVENTION

### Description of Related Art

For free online audio/video streaming services, delivering advertisements in the middle of the media contents is their major source of revenues. Service providers (and their sponsored advertisers) want to make sure that their advertisements are well received by the customers before providing any further streaming contents. This is a popular business model for many streaming services. Due to the lack of control and validation on the advertisement delivery, users might be able to turn off the sound and feed fake signals to the mute checking code logic on the client side streaming program. Or simply connect the devices with an external speakers and mute their external speakers when the advertisement audio broadcasts, then un-mute the speaker again for the next piece of free content (e.g., the next song). Being able to thwart advertising efforts leads to advertisers being wary of advertising on such services and also pushes advertising pricing down as advertisers are not sure that users are actually listening to their paid advertisements.

One approach adopted by some of streaming services is to detect if the client devices (e.g., computer system, mobile phone, etc.) have been put into mute status. This is generally performed by checking whether the mute flags for the built-in device speaker are set in the operating system. However, users can still evade such (indirect) checking by controlling the operating system, client side program (e.g., repackaging app), or by simply connecting the device to an external speaker and muting the external speaker, thus preventing the advertisement from being audible.

### SUMMARY

An approach is provided that receives audible signals from a microphone at a device. The approach compares the received audible signals to an expected audio signal, with the expected audio signal being a first segment playing at the device. A determination is made whether, based on the comparison, the first segment was played at an audible level at the device. If the first segment was audibly played, then the approach plays additional audible content (a second segment, etc.). On the other hand, if the first segment was inaudible, then the approach inhibits further playing of audible content, such as the second segment.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a system diagram of advertisement delivery detection in audio/video streaming services;

FIG. 4 depicts a flowchart showing the delivery of content and advertisements by a streaming service; and

FIG. 5 depicts a flowchart showing details of advertisement delivery and detection by the streaming service.

### DETAILED DESCRIPTION

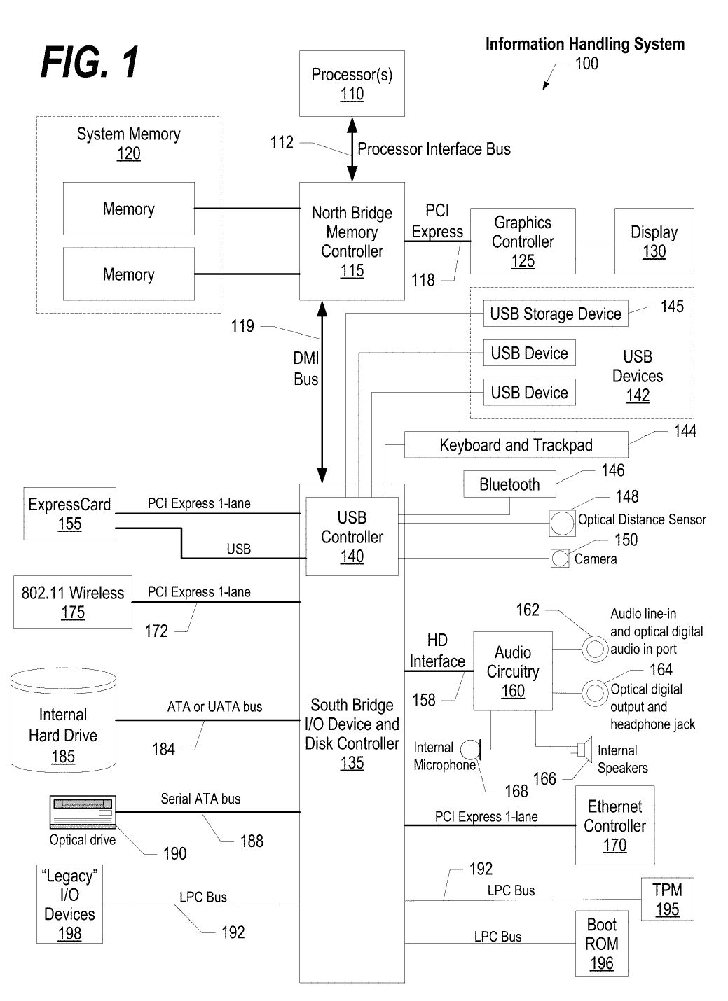

FIGS. 1-5 show an approach where the streaming client application collects audio signals from a built-in microphone at the client device during the broadcast (playing) of the advertisements. The approach compares the samples collected at the microphone with the original audio patterns of the advertisements to verify whether the advertisements are successfully delivered.

The approach can be used with virtually any streaming service that uses audible advertisements to the user. For example, an advertisement might be a piece of recorded audio stream that is inserted between two songs. In one embodiment, the approach randomly selects a set of audio segments (each segment with random time window size) scattered across each advertisement. When an advertisement begins to broadcast, the client app turns on the microphone at these predefined time slots to record, at the device's microphone, the audible audio segments from the advertisement stream. The collected audio segments from the user end can be de-noised and compared with the original audio segments sent to the device based on any number of signal processing techniques, such as using Fast Fourier Transformation, and any number of pattern matching techniques on the server side.

If a sufficiently high enough number of selected segments are successfully matched, the streaming services recognizes that the user audibly played the advertisement and did not mute or otherwise control the volume to the point that such advertisements was inaudible. In this case, the client side app will deliver the next free content to the user. On the other hand, if the streaming service detects that the advertisement was not audibly played at the client device, then the client side app pauses the audio from playing more content and the app notifies the user to play the advertisement at an audible level. This approach ensures that the advertisement is audibly delivered into the physical environment of the client device (e.g., computer system, mobile phone, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

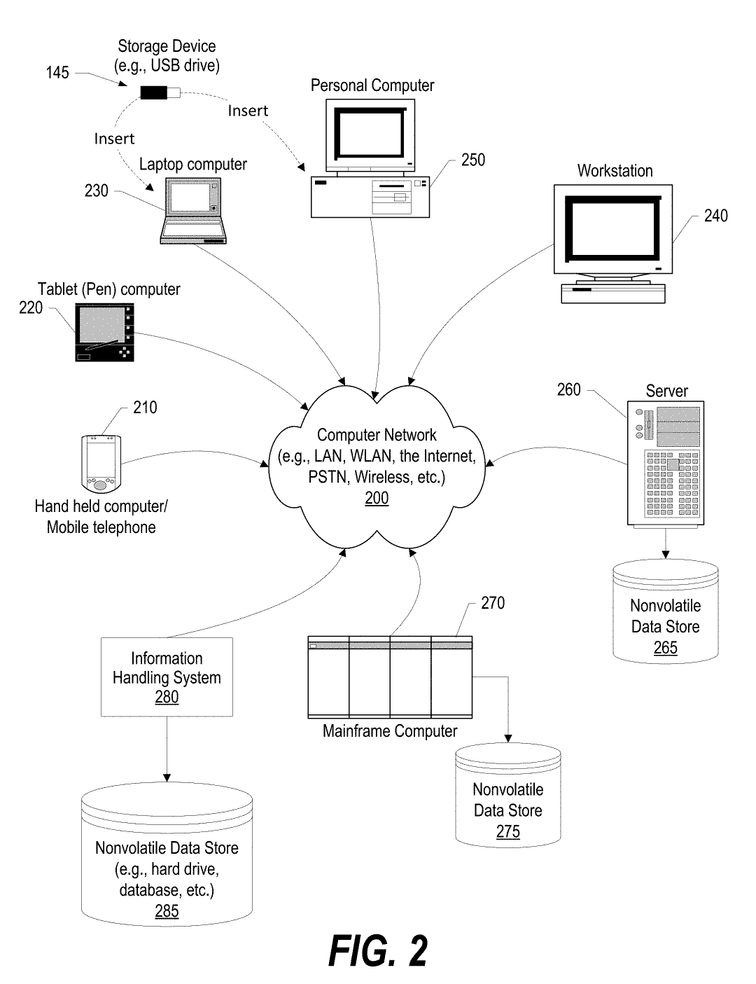

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

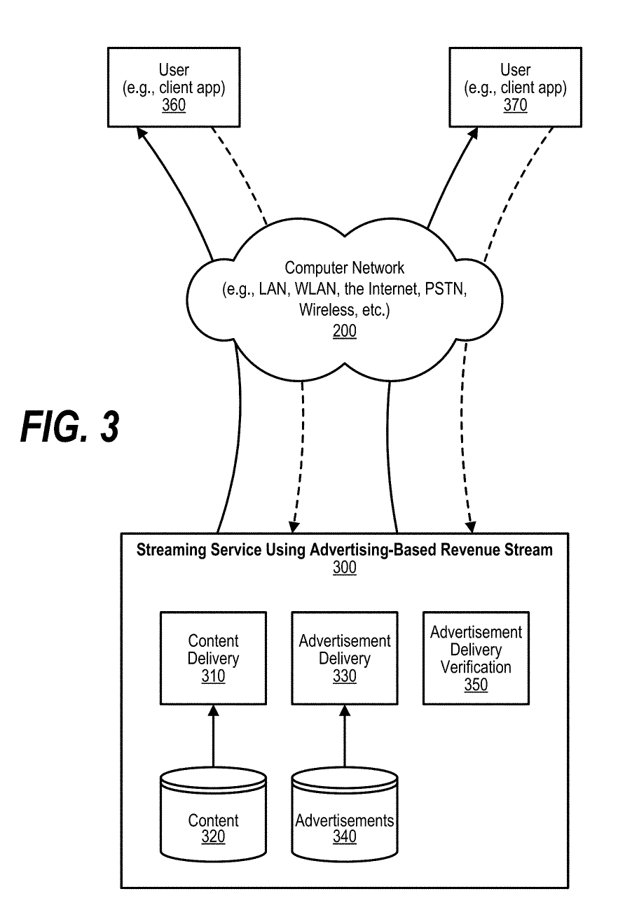

FIG. 3 depicts a system diagram of advertisement delivery detection in audio/video streaming services. Streaming service 300 is a network-based service provider that streams content to users, such as users 360 and 370. Streaming service 300 utilizes an advertising-based revenue stream, or source, in order to provide content either at no-cost or at a reduced cost to the users.

Streaming service 300 utilizes three major processes to provide the service to the users. Content delivery process 310 retrieves content from data store 320 and streams such content, such as music, movies, or the like, to various users. The content streamed to users can be the same content to all users, or can be tailored based on the needs or preferences of the various users.

Advertisement delivery process 330 retrieves advertisements from data store 340 and streams such advertisements to the various users. The advertisements streamed to users can be the same advertisements to all users, or can be tailored based on the needs or preferences of the various users so that a child might receive an advertisement for a toy or game that might be of interest to the child, while an adult might receive an advertisement for an automobile or other product or service that might be of interest to the adult.

Advertisement delivery verification process 350 verifies that the advertisement that was delivered to the user by process 330 was audibly played at the user's device, such as a computer system, mobile phone, etc. If process 350 verifies that the advertisement was played, then the streaming service continues to stream content using process 310 to the user. On the other hand, if process 350 detects that the advertisement was not played at an audible level, then the process inhibits further playing of content until the user audible plays the advertisement. In one embodiment, a notice is played or displayed to the user on the user's device to play the advertisement at an audible level.

While processes 310, 330, and 350 are shown operating by streaming service 300, in one embodiment these processes, or portions thereof, are packaged into a client application, such as a client app, that is running on the client devices. In this embodiment, the client application can open the microphone at the user's device, receive the audible signals playing at the speaker of the user's device, and compare the received audible signals to the expected audio of the advertisement that was expected to be audible at the client device. In this manner, the client application can control further playing of content when advertisements are detected to have been played at an audible level, and can further inhibit playing of further content when such advertisements are inaudible at the client device.

In one embodiment, an advertisement is played as a first segment with the device's microphone detecting whether the first segment (the advertisement) was played at an audible level. If the first segment was played at an audible level, then the process plays additional content, such as a second segment. While advertising is used as one example in FIGS. 1-5, this is just one example and other examples are readily apparent. For instance, in some online education offerings, the provider might ensure that participants offering actually listen to the audible content by using the approach provided herein. In this instance, a first segment might be a first portion of the education offering, with a second segment being a second subsequent portion of the continuing education requirement. In another instance, some jurisdictions allow drivers to reduce or eliminate driving infractions by attending a “safe driving” course that is often provided on-line. In these courses, the course provider can use the approach provided herein to ensure that participants of the course actual listen to the course material by detecting that the material is played at an audible level. In this instance, a first segment might be a first portion of the online safe driving course, with a second segment being a second subsequent portion of the online safe driving course. Using the approach provided herein, a content provider can increase the probability that the receiver of the content is actually listening to the content by detecting that the content is being played at an audible level.

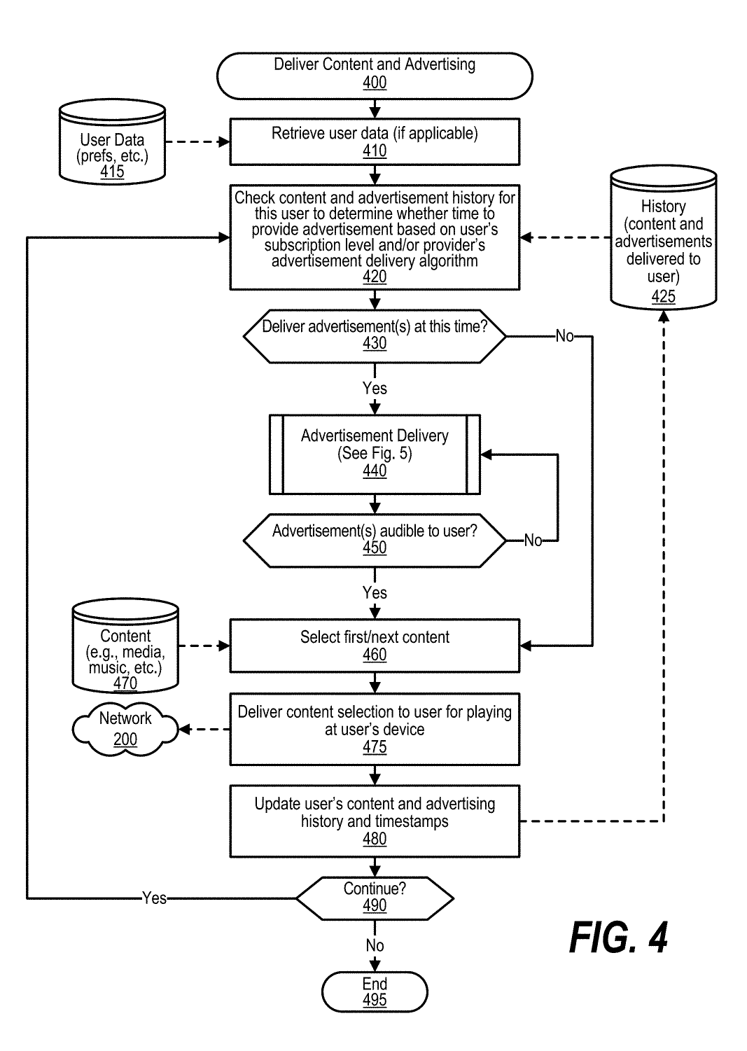

FIG. 4 depicts a flowchart showing the delivery of content and advertisements by a streaming service. FIG. 4 processing commences at 400 and shows the steps taken by a process that delivers content and advertising at a client device. All or part of the process shown in FIG. 4 can be performed at a client application running on the client device, or can be performed at a network-based streaming service. At step 410, the process retrieves user data, if applicable, from data store 415. This user data might include the types of content preferred by the user, such as preferred music genres or performers, etc., the types of advertisements of interest to the user, and any paid subscription level of the user that might reduce the number and/or frequency of advertisements delivered to the user by the streaming service. At step 420, the process checks data store 425 for the content and advertisement history for this user. Here, the process determines whether it is time to provide one or more advertisements to this user based on the user's subscription level and/or provider's advertisement delivery algorithm, and how long it has been since an advertisement was delivered to the user.

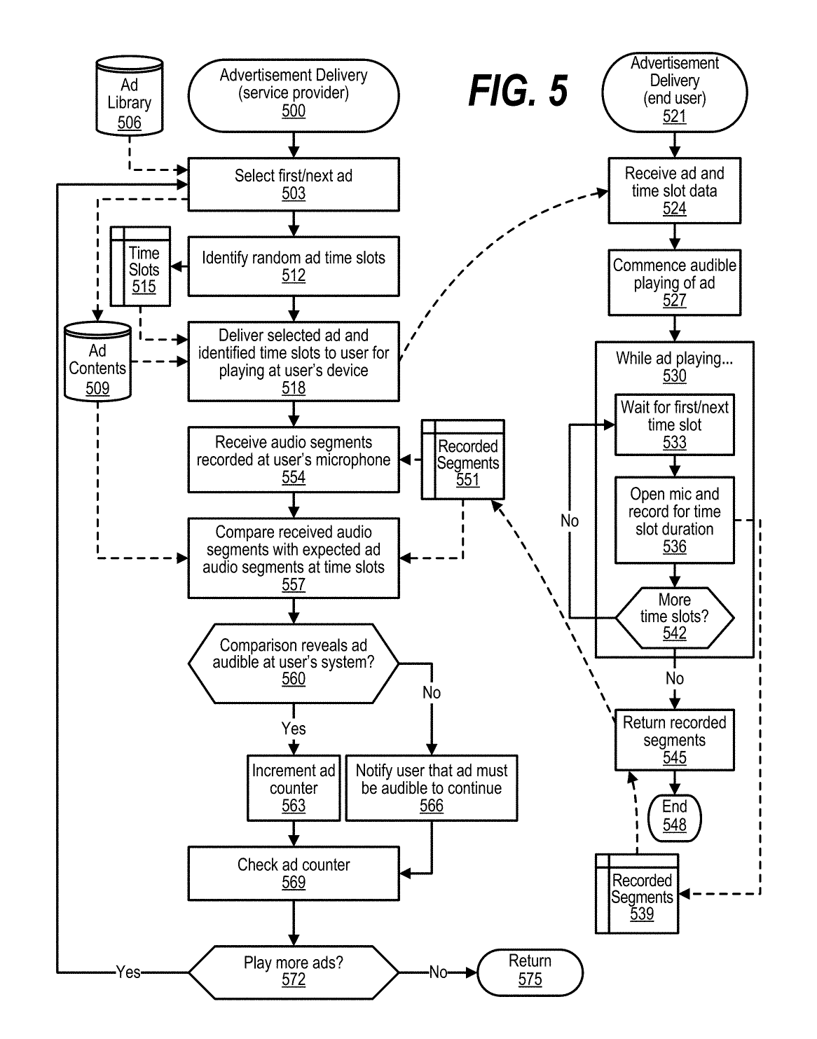

The process determines whether it is time to deliver one or more advertisements to this user (decision 430). If it is time to deliver advertisements to this user, then decision 430 branches to the ‘yes’ branch whereupon, at predefined process 440, the process performs the advertisement delivery process (see FIG. 5 and corresponding text for processing details). After delivery of an advertisement, decision 450 determines whether predefined process 450 determined that the advertisements were audible at the user's device. If the advertisements were inaudible at the user's device, then decision 450 branches to the ‘no’ branch which loops back to predefined process 440 to continue advertisement delivery by predefined process 440. This looping continues until the advertisement was found to be audible at the user's device, at which time decision 450 branches to the ‘yes’ branch exiting the loop. Returning to decision 430, if it is not yet time to deliver advertisements to this user, then decision 430 branches to the ‘no’ branch bypassing predefined process 440 and decision 450.

At step 460, the process selects the first content from data store 470 and, at step 475, the process delivers the content selection to the user's device for playing at user's device, such as audibly playing the content on the device's speakers. At step 480, the process updates the user's content and advertising history and records the updates in data store 425. The update includes timestamps pertaining to when various content and advertisements were delivered to the user. The process determines as to whether processing should continue (decision 490). If processing is continuing, then decision 490 branches to the ‘yes’ branch which loops back to step 420 to continue delivering content and advertisements to the user's device. This looping continues until the user exits or pauses the streaming service, at which point decision 490 branches to the ‘no’ branch exiting the loop. FIG. 4 processing thereafter ends at 495.

FIG. 5 depicts a flowchart showing details of advertisement delivery and detection by the streaming service. FIG. 5 processing commences at 500 and shows the steps taken by a process that performs advertisement delivery at a streaming service provider. Some of the steps shown performed by the service provider can be encapsulated on a client application, such as a client app, and performed at the client device rather than the service provider. At step 503, the service provider process selects the first advertisement from advertising library data store 506 and stores the selected advertisement data in data store 509. At step 512, the service provider process identifies one or more random advertisement time slots that start somewhere during the time that advertisement is played for a duration that ends at or before the ending of the advertisement. These time slots are stored in memory area 515. At step 518, the service provider process delivers the selected advertisement and identified time slots to the user device in order to play the advertisement at the user's device.

User device processing is shown commencing at 521 and shows the steps taken by the process running in the user's device that performs advertisement delivery. At step 524, the user device process receives the advertisement content and the time slot data from the service provider. At step 527, the user device process commences audible playing of the advertisement.

Box 630 depicts steps performed while the advertisement is playing at the user device. These steps include steps 533, 536, and decision 542. At step 533, the user device process waits for the first time slot, at which time the process opens the microphone at the user device and records any audible data for the time slot duration. The recorded segments are stored in memory area 539. The process determines as to whether there more time slots during which audible data is to be captured (decision 542). If there are more time slots, then decision 542 branches to the ‘yes’ branch which loops back to step 533 to wait for the next time slot and then record data for the time slot duration. This looping continues until there are no more time slots, at which point decision 542 branches to the ‘no’ branch exiting the loop. At step 545, the user device process transmits the recorded segments that were stored in memory area 539 back to the service provider. User device processing of advertisement delivery thereafter ends at 548.

At step 554, the service provider process receives the audio segments that were recorded at the user's microphone at the user's device and received at the service provider and stored in memory area 551. At step 557, the service provider process compares the received audio segments from memory area 551 with the expected advertisement audio segments at the various time slots with the advertisement contents being retrieved from data store 509. These collected audio segments from the user device can be de-noised to filter out conversation and other noises in the user's environment and compared with the expected advertisement audio segments based on signal processing (e.g., Fast Fourier Transformation, etc.) and additional pattern matching techniques.

The process determines as to whether the comparison reveals that the advertisement was audible at the user's system (decision 560). If the comparison reveals that the advertisement was audible at the user's system, then decision 560 branches to the ‘yes’ branch whereupon, at step 563, the service provider process increments the advertisement counter indicating that another advertisement was audibly played at the user's device. On the other hand, if the comparison reveals that the advertisement was inaudible at the user's system, then decision 560 branches to the ‘no’ branch whereupon, at step the service provider process notifies user that ad must be audible to continue. This will also cause the advertisement, or a different advertisement, to be re-played at the user's device before additional content (music, etc.) is delivered to the user's device.

At step 569, the service provider process checks the advertisement counter. Based on the advertisement counter, the service provider process determines whether to play additional advertisements at the user's device (decision 572). If more advertisements are to be played, then decision 572 branches to the ‘yes’ branch which loops back to step 503 to select and play the next advertisement as described above. This looping continues until no additional advertisements are to be played at this time, at which point decision 572 branches to the ‘no’ branch exiting the loop. Service provider processing of advertisement delivery thereafter returns to the calling routine (see FIG. 4) at 575.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system that includes a processor and a memory accessible by the processor, the method comprising:
receiving audible signals from a microphone at a device;
comparing the received audible signals to an expected audio signal, wherein the expected audio signal is a first segment playing at the device;
determining, based on the comparison, whether the first segment was played at an audible level at the device;
playing a second segment in response to the determination being that the first segment was played at the audible level; and
inhibiting playing of the second segment in response to the determination being that the first segment was inaudible at the device.

2. The method of claim 1 further comprising:
in response to the determination being that the first segment was inaudible at the device:
notifying a user of the device that the first segment should be audibly played to continue; and
re-playing the first segment at the device.

3. The method of claim 1 further comprising:
selecting one or more time slots during which the first segment is being played at the device; and
recording, at the microphone, the audible signals received at the microphone during the selected time slots, wherein the comparing further compares the audible signals received during the time slots with one or more audio signals expected to play during the time slots.

4. The method of claim 1 wherein the comparing further comprises signal processing that compares the received audible signals to the expected audio signals.

5. The method of claim 1 wherein the receiving, comparing, determining, playing, and inhibiting are performed by a client application of a streaming service.

6. The method of claim 1 further comprising:
playing the first segment at a speaker connected to the device, wherein the playing is performed at an audible level;
opening the microphone at the device;
recording, at the microphone, the audible signals that are received; and
closing the microphone at the device.

7. The method of claim 1 wherein the receiving, comparing, determining, playing, and inhibiting are performed by a streaming service that access the device via a computer network.

8. An information handling system comprising:
one or more processors;
a microphone accessible by at least one of the processors;
a speaker accessible by at least one of the processors;
a memory coupled to at least one of the processors; and
a set of computer program instructions stored in the memory and executed by at least one of the processors in order to perform actions comprising:
receiving audible signals from the microphone;
comparing the received audible signals to an expected audio signal, wherein the expected audio signal is a first segment playing at the speaker;
determining, based on the comparison, whether the first segment was played at an audible level at the speaker;
playing a second segment in response to the determination being that the first segment was played at the audible level; and
inhibiting further playing of the second segment in response to the determination being that the first segment was inaudible at the speaker.

9. The information handling system of claim 8 wherein the actions further comprise:
in response to the determination being that the first segment was inaudible at the device:
notifying a user of the information handling system that the first segment should be audibly played to continue; and
re-playing the first segment at the speaker.

10. The information handling system of claim 8 wherein the actions further comprise:
selecting one or more time slots during which the first segment is being played at the speaker; and
recording, at the microphone, the audible signals received at the microphone during the selected time slots, wherein the comparing further compares the audible signals received during the time slots with one or more audio signals expected to play during the time slots.

11. The information handling system of claim 8 wherein the comparing further comprises signal processing that compares the received audible signals to the expected audio signals.

12. The information handling system of claim 8 wherein the receiving, comparing, determining, playing, and inhibiting are performed by a client application of a streaming service that is stored in the memory and executed by one or more of the processors.

13. The information handling system of claim 8 wherein the actions further comprise:
playing the first segment at the speaker, wherein the playing is performed at an audible level;
opening the microphone;
recording, at the microphone, the audible signals that are received; and
closing the microphone.

14. A computer program product stored in a computer readable storage medium, comprising computer program code that, when executed by an information handling system, performs actions comprising:
receiving audible signals from a microphone at a device;
comparing the received audible signals to an expected audio signal, wherein the expected audio signal is a first segment playing at the device;
determining, based on the comparison, whether the first segment was played at an audible level at the device;
playing a second segment in response to the determination being that the first segment was played at the audible level; and
inhibiting further playing of the second segment in response to the determination being that the first segment was inaudible at the device.

15. The computer program product of claim 14 wherein the actions further comprise:
in response to the determination being that the first segment was inaudible at the device:
notifying a user of the device that the first segment should be audibly played to continue; and
re-playing the first segment at the device.

16. The computer program product of claim 14 wherein the actions further comprise:
selecting one or more time slots during which the first segment is being played at the device; and
recording, at the microphone, the audible signals received at the microphone during the selected time slots, wherein the comparing further compares the audible signals received during the time slots with one or more audio signals expected to play during the time slots.

17. The computer program product of claim 14 wherein the comparing further comprises signal processing that compares the received audible signals to the expected audio signals.

18. The computer program product of claim 14 wherein the receiving, comparing, determining, playing, and inhibiting are performed by a client application of a streaming service.

19. The computer program product of claim 14 wherein the actions further comprise:
playing the first segment at a speaker connected to the device, wherein the playing is performed at an audible level;
opening the microphone at the device;
recording, at the microphone, the audible signals that are received; and
closing the microphone at the device.

20. The computer program product of claim 14 wherein the receiving, comparing, determining, playing, and inhibiting are performed by a streaming service that access the device via a computer network.
